(19) United States
(12) Patent Application Publication
(10) Pub. No.: US 2026/0046841 A1
(43) Pub. Date: Feb. 12, 2026

(54) CONFIGURATION OF CYCLIC PREFIX EXTENSION STARTING POSITIONS

(71) Applicant: QUALCOMM INCORPORATED, San Diego, CA (US)

(72) Inventors: Giovanni CHISCI, San Diego, CA (US); Chih-Hao LIU, San Diego, CA (US); Stelios STEFANATOS, San Diego, CA (US); Jing SUN, San Diego, CA (US); Xiaoxia ZHANG, San Diego, CA (US)

(21) Appl. No.: 19/102,591

(22) PCT Filed: Aug. 2, 2023
(86) PCT No.: PCT/US2023/071520

§ 371 Date: Feb. 10, 2025

(30) Foreign Application Priority Data
Nov. 4, 2022 (GR) 20220100902

(51) Int. Cl. H04W 72/02; H04W 72/0446; H04W 72/25

(52) U.S. Cl. CPC H04W 72/02; H04W 72/0446; H04W 72/25

(57) ABSTRACT

Various aspects of the present disclosure generally relate to wireless communication. In some aspects, a user equipment (UE) may receive, from a network node, a configuration that indicates one or more cyclic prefix extension (CPE) starting positions. The UE may transmit a sidelink transmission using a selected CPE starting position, of the one or more CPE starting positions, based at least in part on the configuration received from the network node. Numerous other aspects are described.

### CROSS-REFERENCE TO RELATED APPLICATION

This Patent Application claims priority to Greek Nonprovisional Patent Application No. 20220100902, filed on Nov. 4, 2022, entitled “CONFIGURATION OF CYCLIC PREFIX EXTENSION STARTING POSITIONS,” which is hereby expressly incorporated by reference herein.

### FIELD OF THE DISCLOSURE

Aspects of the present disclosure generally relate to wireless communication and to techniques and apparatuses for a configuration of cyclic prefix extension (CPE) starting positions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, a configuration that indicates one or more cyclic prefix extension (CPE) starting positions; and transmit a sidelink transmission using a selected CPE starting position, of the one or more CPE starting positions, based at least in part on the configuration received from the network node.

In some implementations, an apparatus for wireless communication at a network node includes a memory and one or more processors, coupled to the memory, configured to: transmit, to a UE, a configuration that indicates one or more CPE starting positions, wherein a sidelink transmission using a selected CPE starting position, of the one or more CPE starting positions is based at least in part on the configuration.

In some implementations, a method of wireless communication performed by a UE includes receiving, from a network node, a configuration that indicates one or more CPE starting positions; and transmitting a sidelink transmission using a selected CPE starting position, of the one or more CPE starting positions, based at least in part on the configuration received from the network node.

In some implementations, a method of wireless communication performed by a network node includes transmitting, to a UE, a configuration that indicates one or more CPE starting positions, wherein a sidelink transmission using a selected CPE starting position, of the one or more CPE starting positions is based at least in part on the configuration.

In some implementations, a non-transitory computer-readable medium storing a set of instructions for wireless communication includes one or more instructions that, when executed by one or more processors of a UE, cause the UE to: receive, from a network node, a configuration that indicates one or more CPE starting positions; and transmit a sidelink transmission using a selected CPE starting position, of the one or more CPE starting positions, based at least in part on the configuration received from the network node.

In some implementations, a non-transitory computer-readable medium storing a set of instructions for wireless communication includes one or more instructions that, when executed by one or more processors of a network node, cause the network node to: transmit, to a UE, a configuration that indicates one or more CPE starting positions, wherein a sidelink transmission using a selected CPE starting position, of the one or more CPE starting positions is based at least in part on the configuration.

In some implementations, an apparatus for wireless communication includes means for receiving, from a network node, a configuration that indicates one or more CPE starting positions; and transmitting a sidelink transmission using a selected CPE starting position, of the one or more CPE starting positions, based at least in part on the configuration received from the network node.

In some implementations, an apparatus for wireless communication includes means for transmitting, to a UE, a configuration that indicates one or more CPE starting positions, wherein a sidelink transmission using a selected CPE starting position, of the one or more CPE starting positions is based at least in part on the configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a single cyclic prefix extension (CPE) starting position, in accordance with the present disclosure.

FIG. 5 is a diagram illustrating an example of multiple CPE starting positions, in accordance with the present disclosure.

FIG. 6 is a diagram illustrating an example of reserved CPEs and priority CPEs, in accordance with the present disclosure.

FIG. 7 is a diagram illustrating an example of prioritized transmissions, in accordance with the present disclosure.

FIG. 8 is a diagram illustrating an example of prioritized transmissions, in accordance with the present disclosure.

FIG. 9 is a diagram illustrating an example associated with a configuration of CPE starting positions, in accordance with the present disclosure.

FIGS. 10-11 are diagrams illustrating example processes associated with a configuration of CPE starting positions, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

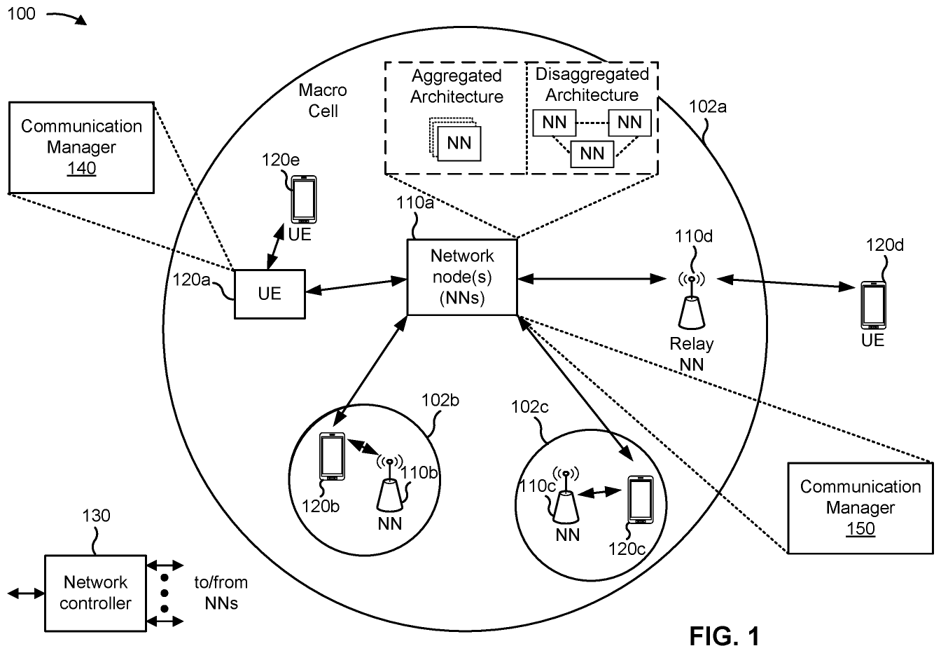

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a configuration that indicates one or more cyclic prefix extension (CPE) starting positions; and transmit a sidelink transmission using a selected CPE starting position, of the one or more CPE starting positions, based at least in part on the configuration received from the network node. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a configuration that indicates one or more CPE starting positions, wherein a sidelink transmission using a selected CPE starting position, of the one or more CPE starting positions is based at least in part on the configuration. Additionally, or alternatively, the communication manager 150 may perform one or more other operations described herein.

As indicated above, FIG. 1 is provided as an example. Other examples may differ from what is described with regard to FIG. 1.

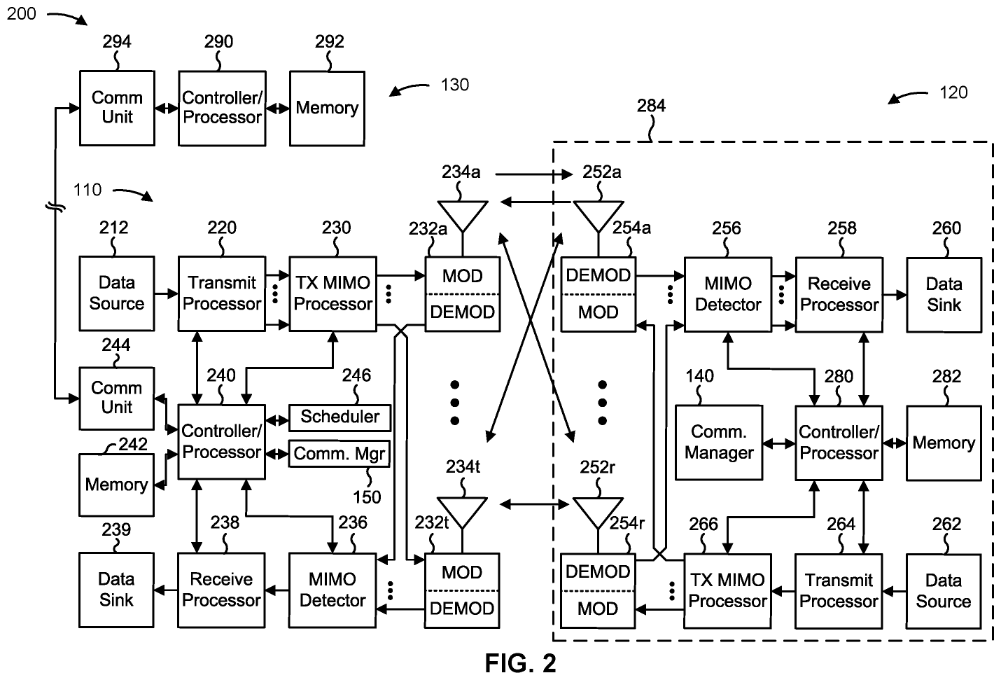

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

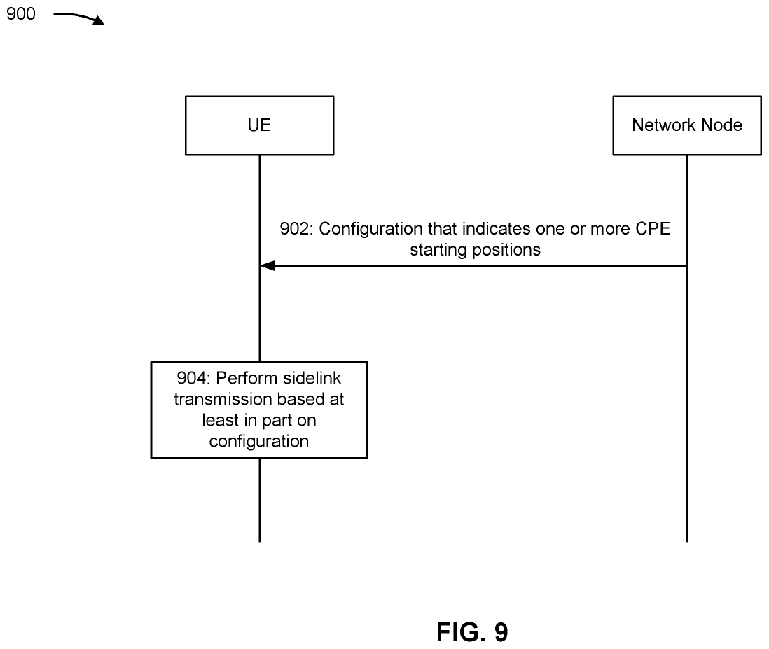

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-13).

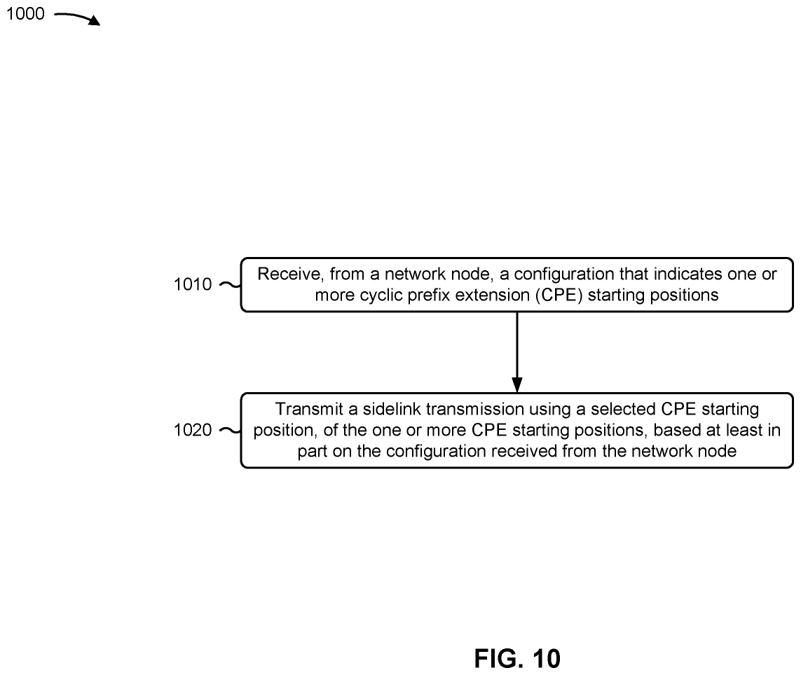

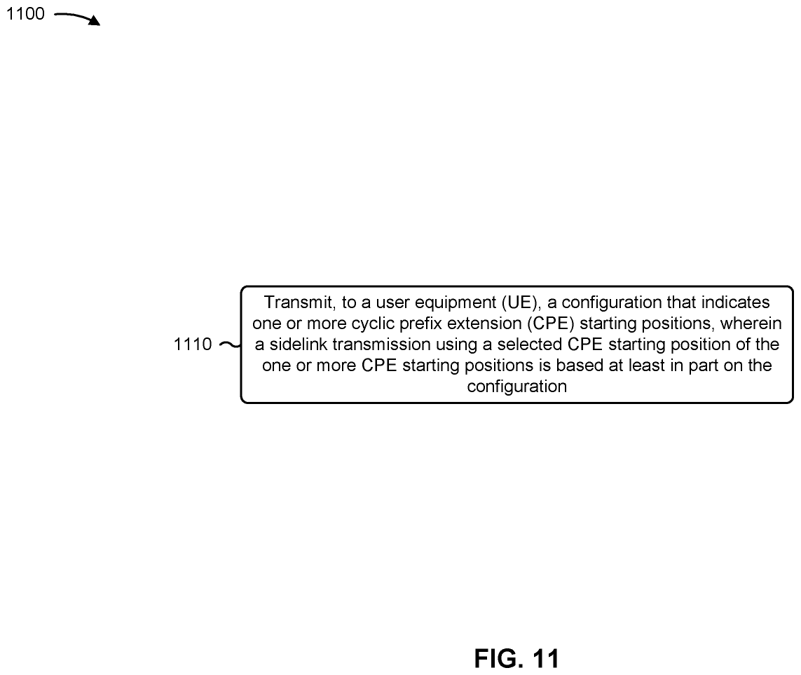

The controller/processor 240 of the network node 110, the controller/processor 280 of the UE 120, and/or any other component(s) of FIG. 2 may perform one or more techniques associated with a configuration of CPE starting positions, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, a configuration that indicates one or more CPE starting positions; and/or means for transmitting a sidelink transmission using a selected CPE starting position, of the one or more CPE starting positions, based at least in part on the configuration received from the network node. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a configuration that indicates one or more CPE starting positions, wherein a sidelink transmission using a selected CPE starting position, of the one or more CPE starting positions is based at least in part on the configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

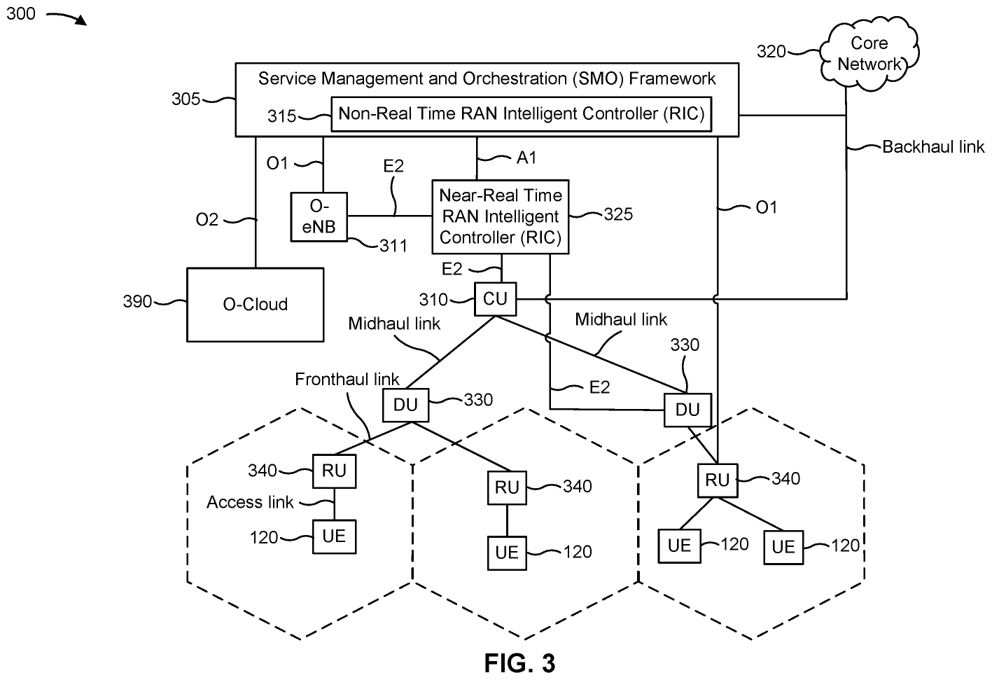

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A sidelink may be supported on an unlicensed spectrum for both a mode 1 and a mode 2. A Uu operation for mode 1 may be limited to a licensed spectrum. Channel access mechanisms from NR unlicensed (NR-U) may be reused for a sidelink unlicensed operation. The sidelink unlicensed operation may be associated with a sidelink resource reservation. An existing NR sidelink and NR-U channel structure may be reused as a baseline for the sidelink unlicensed operation. The sidelink unlicensed operation may be associated with FR1 unlicensed bands. In the sidelink unlicensed operation, a network node may not perform a Type 1 channel access to initiate and share a channel occupancy. The network node may not perform a Type 2 channel access to share an initiated channel occupancy. Further, the network node may not perform semi-static channel access procedures to access an unlicensed channel.

NR sidelink transmissions may start at a specific symbol boundary. Potential collisions may be resolved by a network node scheduling (mode 1), or by resource reservations and inter-UE coordination signaling (mode 2). In mode 1, the network node may allocate resources for sidelink communications between UEs. In mode 2, UEs may autonomously select resources for sidelink communications.

In SL-U, due to listen-before-talk (LBT) uncertainty, collision resolution based at least in part on signaling may be unreliable, so a distributed mechanism for collision resolution may be needed. NR-U may use, for a configured grant physical uplink shared channel (CG-PUSCH), multiple random CPE starting positions along with LBT to resolve collisions. In NR-U, when a UE starts transmitting at an earlier position, the UE may block an LBT of another UE that selects a later position, thereby avoiding a collision due to an aligned transmission starting position. Multiple random CPE starting positions may be applied to SL-U to improve collision resolution. Further, for SL-U, prioritizations may be applied to boost high priority transmissions in congested scenarios.

A CPE may be transmitted from a CPE starting position until a start of a next automatic gain control (AGC) symbol. A single CPE starting position may be supported. Multiple CPE starting positions may be supported. The single CPE starting multiple or the multiple CPE starting positions may be used based at least in part on a pre-configuration. The single CPE starting position and the multiple CPE starting positions may be associated with various scenarios, such as inside and outside a channel occupancy time (COT), type(s) of sidelink transmissions, a mode 1 resource allocation, and/or a mode 2 resource allocation. The type(s) of sidelink transmissions may include physical sidelink shared channel (PSSCH) transmissions, physical sidelink control channel (PSCCH) transmissions, physical sidelink feedback channel (PSFCH) transmissions, and/or sidelink synchronization signal block (S-SSB) transmissions.

The single CPE starting position may be able to preserve a frequency division multiplexing (or a frequency division multiplex) (FDM) from NR sidelink. With the single CPE starting position, a legacy collision avoidance may be applied, which may involve a network node control, reservations, and inter-UE coordination signaling. In some cases, both the single CPE starting position and the multiple CPE starting positions may be supported, but further distribution collision avoidance may be needed to the unreliability of a signaling-based approach (e.g., channel access uncertainty). The single CPE starting position and the multiple CPE starting positions may be pre-configurable per resource pool. In a single CPE starting position resource pool, the CPE starting position may be a fixed point (e.g., after 16 or 25 microseconds (μs) from a gap symbol start, and for both a PSFCH and a PSSCH) with no flexibility/controllability. In a multiple CPE starting positions resource pool, the multiple CPE starting positions may not be used all the time for all channels, and the single CPE starting position may still be used (e.g., for the PSFCH, and/or based at least in part on conditions for the PSSCH).

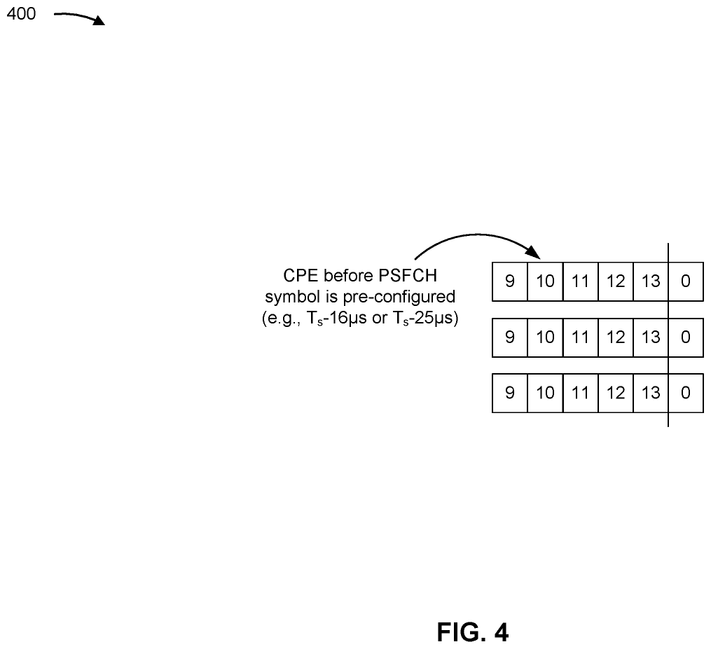

FIG. 4 is a diagram illustrating an example 400 of a single CPE starting position, in accordance with the present disclosure.

As shown in FIG. 4, a single CPE starting position may be preconfigured to exist before a PSFCH symbol (e.g., Tₛ−16 μs or Tₛ−25 μs). The single CPE starting position may support a PSFCH, which may be based at least in part on a low chance of collision in a resource pool due to a mapping and a desire to not block other transmissions. The single CPE starting position may apply regardless of a starting COT or COT sharing among UEs.

As indicated above, FIG. 4 is provided as an example. Other examples may differ from what is described with regard to FIG. 4.

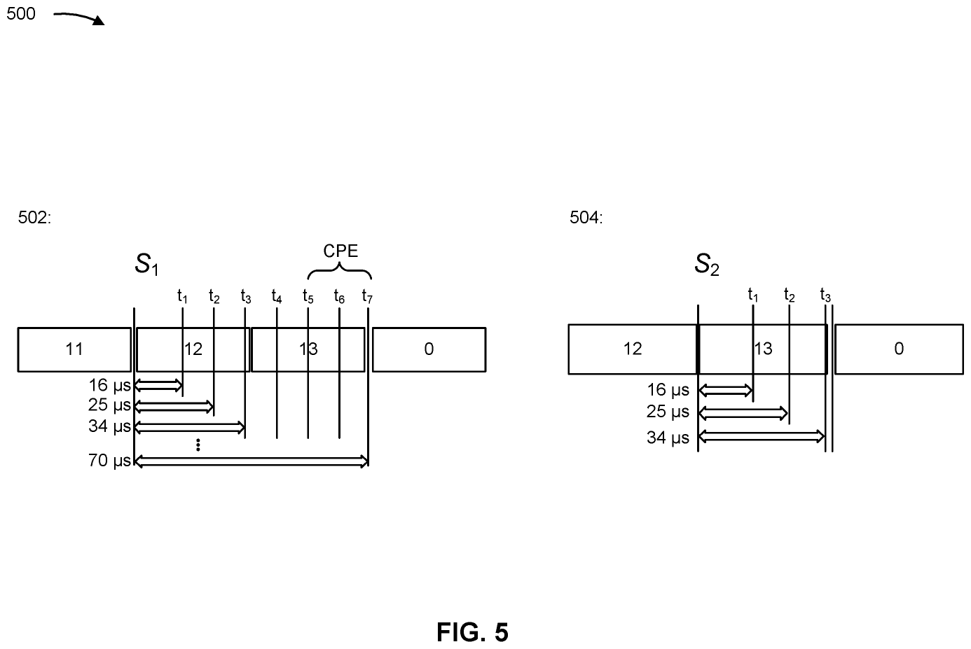

FIG. 5 is a diagram illustrating an example 500 of multiple CPE starting positions, in accordance with the present disclosure.

Multiple CPE starting position locations may be available to start transmissions for a PSSCH. As shown by reference number 502, a set S₁ (e.g., two 30 KHz symbols) may be defined for a COT initiation. As shown by reference number 504, a set S₂ (e.g., only a symbol 13 gap) may be defined for COT sharing. A CPE may be selected according to a priority, but may also better support FDM. FDM may be associated with a reserved CPE (or common CPE). For example, the reserved CPE may be one CPE among the set S₁ or the set S₂ that is reserved for FDM. FDM may be supported at two levels. Each CPE may be associated with a starting position. A first level may be associated with whether FDM is possible (e.g., a resource allocation for a less than full resource block set). A second level may be associated with whether FDM is able to be guaranteed (e.g., network node control, reservation, or inter-UE coordination). Associating FDM with the reserved CPE may have issues depending on whether the reserved CPE should be before or after other priority CPEs (e.g., fail cases may be present). Other interpretations of the reserved CPE may be considered to mitigate such issues (e.g., a reserved CPE for reserved transmissions). A design of a distributed scheme should allow collision resolution with correct prioritization, as well as FDM. The design of the distributed scheme may consider whether a reservation is not detected versus detected for the same slot. The design of the distributed scheme may consider whether a transmission is a first transmission or a retransmission. The design of the distributed scheme may consider whether a resource allocation is for a full resource block set or a partial resource block set.

As indicated above, FIG. 5 is provided as an example. Other examples may differ from what is described with regard to FIG. 5.

A reserved CPE may be assigned to a partial resource block set allocation. For a full resource block set, a priority CPE may be used (e.g., only priority CPE). For a partial resource block set, the reserved CPE may be used (e.g., only reserved CPE). The partial resource block set may be potentially associated with FDM. In this case, only the resource block set allocation (e.g., partial or full) is used to determine whether the priority CPE should be used or the reserved CPE should be used.

A reserved CPE may be associated with a partial resource block set allocation. For example, the reserved CPE may be open only to, but not necessarily used by, the partial resource block set allocation. Candidate resources from a PHY layer may be marked as a candidate slot not overlapped with reservations, a candidate slot overlapped with reservations (but no overlap of subchannels), or a candidate slot overlapped with reservations (and overlap of subchannels).

When a MAC layer selects the candidate slot not overlapped with reservations, and when the selected candidate slot is associated with a full resource block set, a priority CPE may be used. When the MAC layer selects the candidate slot not overlapped with reservations, and when the selected candidate slot is associated with a partial resource block set, a priority CPE may be used for a first transmission (e.g., only a likelihood of FDM is not sufficient) and a reserved CPE may be used for a retransmission (e.g., FDM is possible).

When a MAC layer selects the candidate slot overlapped with reservations (but no overlap of subchannels), and when the selected candidate slot is associated with a full resource block set, neither a priority CPE nor a reserved CPE are available. When the MAC layer selects the candidate slot overlapped with reservations (but no overlap of subchannels), and when the selected candidate slot is associated with a partial resource block set, a reserved CPE may be used for a first transmission (e.g., FDM is possible) and a reserved CPE may be used for a retransmission (e.g., FDM is possible).

When a MAC layer selects the candidate slot overlapped with reservations (and overlap of subchannels), and when a selected candidate slot is associated with a full resource block set, a priority CPE may be used. When the MAC layer selects the candidate slot overlapped with reservations (and overlap of subchannels), and when the selected candidate slot is associated with a partial resource block set, a priority CPE may be used for a first transmission (e.g., a concede is possible) and a reserved CPE may be used for a retransmission (e.g., collision is possible).

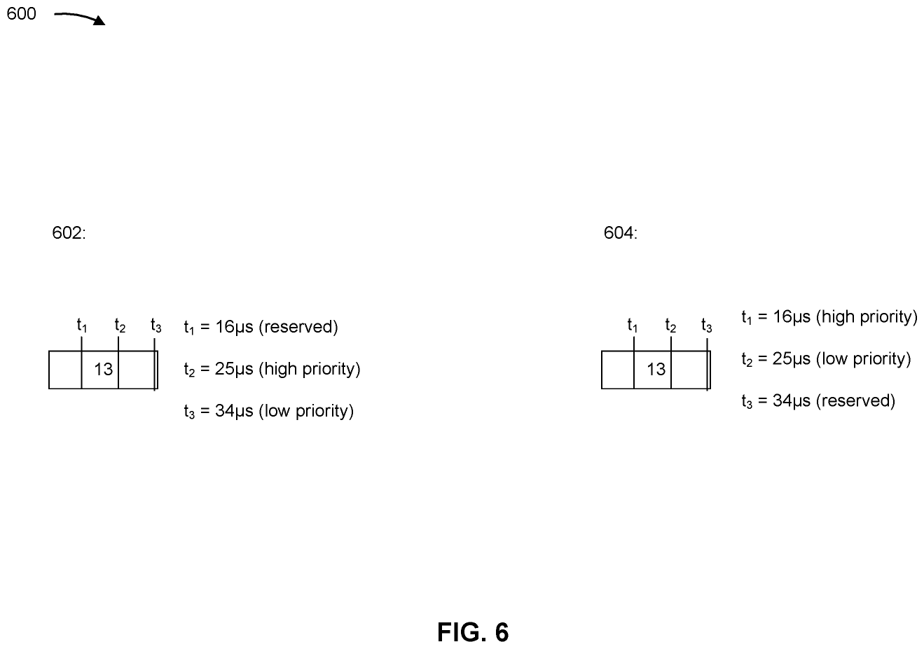

FIG. 6 is a diagram illustrating an example 600 of reserved CPEs and priority CPEs, in accordance with the present disclosure.

As shown by reference number 602, a reserved CPE may be located before priority CPEs. For example, a reserved CPE may be associated with t₁, a high priority CPE may be associated with t₂, and a low priority CPE may be associated with t₃. As shown by reference number 604, a reserved CPE may be located after priority CPEs. For example, a high priority CPE may be associated with t₁, a low priority CPE may be associated with t₂, and a reserved CPE may be associated with t₃.

As indicated above, FIG. 6 is provided as an example. Other examples may differ from what is described with regard to FIG. 6.

A reserved CPE may be associated with a partial resource block set allocation. For example, the reserved CPE may be open only to the partial resource block set allocation. A full resource block set may not be used for the reserved CPE. A reserved CPE may be used along priority CPEs, and a relative location of the reserved CPE may be defined. In a first option, the reserved CPE may be located before the priority CPEs. The reserved CPE may be used by a transmission associated with the partial resource block set, based at least in part on a reservation or a frequency division multiplexing with a reservation, and with a priority. When a transmission has been reserved but is not associated with the full resource block set, the transmission may be constrained to occur afterwards, thus being disadvantaged by another transmission that is associated with the partial resource block set. In a second option, the reserved CPE may be located after priority CPEs. A reserved CPE may be populated by a partial resource block set transmission with any priority. A high priority transmission may be blocked by a low priority transmission that is associated with the full resource block set. Using the reserved CPE and priority CPEs dynamically may have fail cases when the reserved CPE is located before or after the priority CPEs. Full resource block set transmissions or the partial resource block set transmission may be prioritized. In this case, a per-resource-pool pre-configuration may be useful. A first resource pool may be associated with FDM with a single CPE only, and a second resource pool may be associated with a combination of the reserved CPE and the priority CPEs, but the reserved CPE may be located after the priority CPEs.

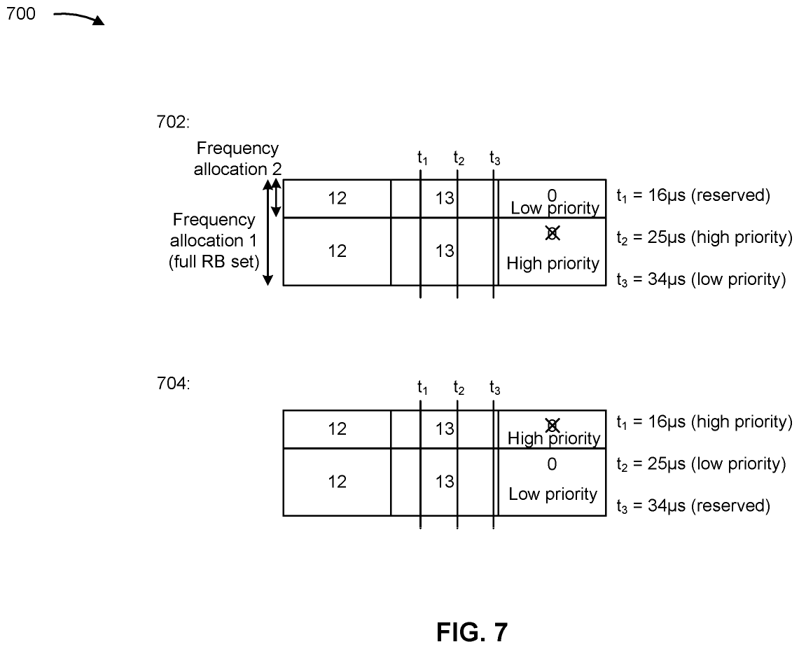

FIG. 7 is a diagram illustrating an example 700 of prioritized transmissions, in accordance with the present disclosure.

As shown by reference number 702, a reserved CPE may be located before priority CPEs (e.g., before a high priority CPE and a low priority CPE). The reserved CPE may be used for a transmission associated with a partial resource block set and with any priority. A high priority transmission may be blocked by a low priority transmission because the high priority transmission may be associated with a full resource block set. The low priority transmission may be associated with the reserved CPE, which may be located before the priority CPEs.

As shown by reference number 704, a reserved CPE may be located after priority CPEs (e.g., after a high priority CPE and a low priority CPE). The reserved CPE may be used for a transmission associated with a partial resource block set and with any priority. A high priority transmission may be blocked by a low priority transmission because the high priority transmission may be associated with a full resource block set, and the low priority transmission may be associated with the partial resource block set.

As indicated above, FIG. 7 is provided as an example. Other examples may differ from what is described with regard to FIG. 7.

A reserved CPE may be associated with reserved transmissions (e.g., both full and partial resource block sets). For example, the reserved CPE may be open only to reserved transmissions. Candidate resources from a PHY layer may be marked as a candidate slot not overlapped with reservations, a candidate slot overlapped with reservations (but no overlap of subchannels), or a candidate slot overlapped with reservations (and overlap of subchannels).

When a MAC layer selects the candidate slot not overlapped with reservations, and when the selected candidate slot is associated with a full resource block set, a priority CPE may be used for a first transmission and a reserved CPE may be used for a retransmission. When the MAC layer selects the candidate slot not overlapped with reservations, and when the selected candidate slot is associated with a partial resource block set, a priority CPE may be used for a first transmission and a reserved CPE may be used for a retransmission.

When a MAC layer selects the candidate slot overlapped with reservations (but no overlap of subchannels), and when the selected candidate slot is associated with a full resource block set, neither a priority CPE nor a reserved CPE may be used. When the MAC layer selects the candidate slot overlapped with reservations (but no overlap of subchannels), and when the selected candidate slot is associated with a partial resource block set, a reserved CPE or a priority CPE may be used for a first transmission, and a reserved CPE may be used for a retransmission.

When a MAC layer selects the candidate slot overlapped with reservations (and overlap of subchannels), and when a selected candidate slot is associated with a full resource block set, a priority CPE may be used may be used for a first transmission and a reserved CPE may be used for a retransmission. When the MAC layer selects the candidate slot overlapped with reservations (and overlap of subchannels), and when the selected candidate slot is associated with a partial resource block set, a priority CPE may be used for a first transmission and a reserved CPE may be used for a retransmission.

When the reserved CPE is open only to reserved transmissions (both full and partial resource block sets), an unfairness between full resource block sets and partial resource block sets may be eliminated because the reserved CPE may be associated with reservations and not to partial resource block sets. An FDM capability may be provided using the reserved CPE. Collisions in the reserved CPE may still be present, although a reselection check may help to avoid collisions, a majority of collisions may be avoided.

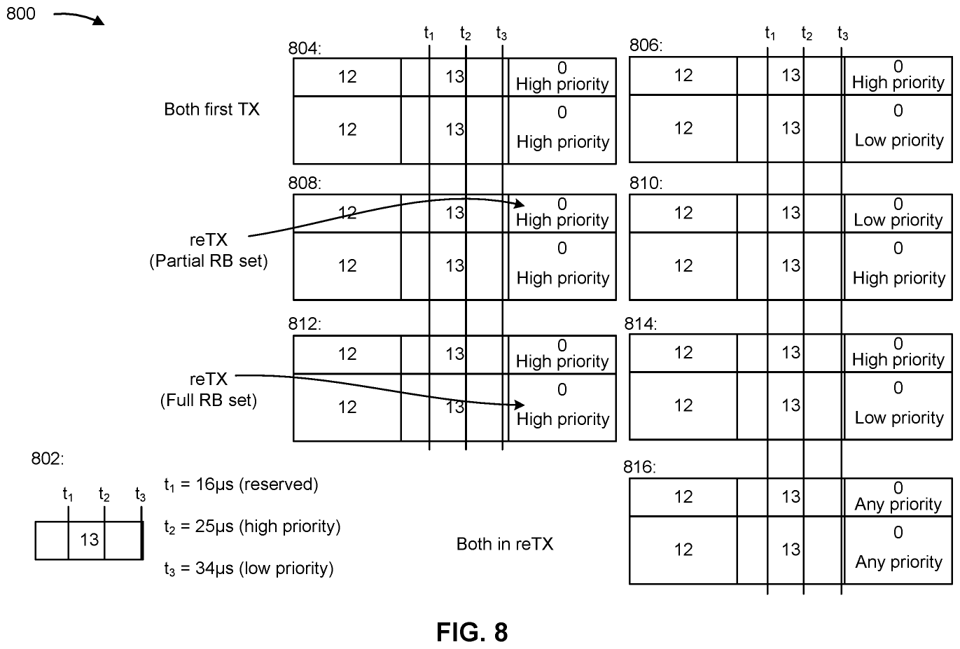

FIG. 8 is a diagram illustrating an example 800 of prioritized transmissions, in accordance with the present disclosure.

As shown by reference number 802, a reserved CPE may be located before a high priority CPE and a low priority CPE. As shown by reference number 804, two first transmissions may both be associated with the same priority (e.g., high priority). In this case, the two first transmissions may collide with each other. As shown by reference number 806, one first transmission may be associated with a high priority, and another first transmission may be associated with a low priority. In this case, the first transmission associated with the low priority may be blocked by the first transmission associated with the low priority. As shown by reference number 808, a retransmission may be associated with a high priority and a first transmission may be associated with a high priority. In this case, the first transmission associated with the high priority may be blocked by the retransmission associated with the high priority. Further, a reserved CPE may be associated with a partial resource block set. As shown by reference number 810, a retransmission may be associated with a low priority, and a first transmission may be associated with a high priority. In this case, the first transmission associated with the high priority may be blocked by the retransmission associated with the low priority. Further, a reserved CPE may be associated with a partial resource block set.

As shown by reference number 812, a first transmission may be associated with a high priority and a retransmission may be associated with a high priority. In this case, the first transmission associated with the high priority may be blocked by the retransmission associated with the high priority. Further, a reserved CPE may be associated with a full resource block set. As shown by reference number 814, a first transmission may be associated with a high priority, and a retransmission may be associated with a low priority. In this case, the first transmission associated with the high priority may be blocked by the retransmission associated with the low priority. Further, a reserved CPE may be associated with a full resource block set. As shown by reference number 816, two retransmissions may both be associated with the same priority (e.g., any priority). In this case, the two retransmissions may collide with each other.

As indicated above, FIG. 8 is provided as an example. Other examples may differ from what is described with regard to FIG. 8.

Pre-configured FDM resource pools may be defined. A single CPE starting position versus multiple CPE starting positions may be per resource pool (e.g., FDM resource pools). In a first resource pool, which may be associated with the single CPE starting position, transmissions (e.g., all transmissions) may start at a given point to favor alignment and FDM behavior. In a second resource pool, which may be associated with multiple CPE starting positions, transmissions (e.g., all transmissions) may select a particular CPE starting position according to priority, which may favor a time division multiplexing (TDM) behavior. In the second resource pool, the single CPE starting position may be used according to certain rules.

When reservations are not detected, there is no guarantee that a UE will FDM with another UE, and a collision may occur even when the quantity of selected subchannels is relatively small. When a UE performs a first transmission, the UE has not committed on any resource to other UEs, so the UEs may behave independently. A collision may occur when UEs use the same CPE, or a blockage may occur when UEs use different CPEs, regardless of the quantity of selected subchannels. When a UE allocates a full resource block set, FDM may not be possible, but a collision may be possible. The UE may protect its high priority traffic with a long CPE. When the UE allocates a less than full resource block set (e.g., a partial resource block set), a reserved CPE may be used to maximize an FDM likelihood, but FDM may occur when other UEs also allocate less than full resource block sets and also select non-overlapping subchannels. Two fail cases may occur. In a first fail case, the other UEs have a full resource block set allocation. When the reserved CPE is before priority CPEs, low priority traffic that attempts to use FDM may block high priority traffic (associated with the full resource block set) that is using its priority-related CPE. When the reserved CPE is after the priority CPEs, high priority traffic that attempts to FDM may be blocked by low priority traffic (associated with the full resource block set) that is using its low-priority-related CPE. In a second fail case, the other UEs may have the less than full resource block set allocation but overlapping subchannels. In this case, UEs may collide with each other. When the UEs use priority CPEs, a high priority may be protected, while a low priority may be blocked. When no external reservations are detected and for a first transmission, a single CPE starting position configuration for both the full resource block set allocation and the less than full resource block set allocation may not be supported, because collisions may still occur in both cases.

When reservations are not detected, there is no guarantee that a UE will FDM with another UE, and a collision may occur even when the quantity of selected subchannels is relatively small. When a UE performs a retransmission, the UE may be committed on resources to use to other UEs. The UE may consider the resources in exclusion or based at least in part on a re-evaluation check. Depending on mutual priority and an RSRP threshold in exclusion, as well as other parameters such as a packet delay budget (PDB), a second UE may be able to FDM (for a partial resource block set), or accept a collision, or select some other slot. When a UE allocates a full resource block set, FDM may not be possible, but a collision may be possible. The UE may protect its high priority traffic with a long CPE. Depending on a mutual position of a reserved CPE and priority CPEs, using a priority CPE may be disadvantageous, so a retransmission may be associated with the reserved CPE. When the UE allocates a less than full resource block set (e.g., a partial resource block set), a reserved CPE may be used to maximize an FDM likelihood. FDM may occur based at least in part on a second UE, which may be a reservation receiver. The second UE may exclude resources. The second UE may identify another slot, or may FDM in the same slot. Alternatively, the second UE may exclude the resources. The second UE may select non-overlapped resources, which may enable FDM. The second UE may select overlapped resources, which may not support FDM. The second UE may protect with priority to avoid collision. When no external reservations are detected and for a retransmission, a single CPE starting position configuration in the less than full resource block set allocation may be supported to provide UEs an opportunity to FDM when a selection excludes a resource reserved by another UE.

When reservations are detected, such information may be used to determine whether to align and FDM without blocking, or when FDM is not achieved. When a UE performs a first transmission, the UE has not committed on any resource to other UEs, and may identify the received reservation. A second UE may be able to FDM for a partial resource block set, or accept collision, or select some other slot. When the UE allocates a full resource block set, FDM may not be possible, but a collision may be possible. The UE may protect its high priority traffic with a long CPE. When the reservation is detected for the same slot, another transmission may occupy a reserved CPE. When the reserved CPE is located before priority CPEs, a first transmission may be blocked, which may be acceptable because the other transmission is reserved. When the UE allocates a less than full resource block set (e.g., the partial resource block set), a reserved CPE may be used to maximize an FDM likelihood. An alignment to the reserved CPE may be made when an FDM is performed with a reservation. A priority CPE may be used when a selection is made with at least a partial overlap. When the reserved CPE is located before priority CPEs, a corresponding transmission may be deprioritized as compared to a reserved transmission. When reservations are received, an attempt of FDM may be performed. When FDM is possible, the reserved CPE may be used. When FDM is not possible (e.g., due a partial overlap of subchannels or use of another slot), a priority CPE may be used.

When reservations are detected, such information may be used to determine whether to align and FDM without blocking, or when FDM is not achieved. When a UE performs a retransmission, the UE may be committed on resource to use to other UEs. The UE may consider the resources in exclusion or based at least in part on a re-evaluation check. A second UE may be able to FDM (for a partial resource block set), or accept a collision, or select some other slot. When a UE allocates a full resource block set, FDM may not be possible, but a collision may be possible. The UE may protect its high priority traffic with a long CPE. When the reservation is detected for the same slot, another transmission may occupy a reserved CPE. When the reserved CPE is located before priority CPEs, a first transmission may be blocked, which may not be acceptable because a full resource block set transmission was reserved and should not concede to another reservation. To resolve this issue, the reserved CPE may be associated with a reservation and not to FDM. When the UE allocates a less than full resource block set (e.g., the partial resource block set), a reserved CPE may be used to maximize an FDM likelihood. An alignment to the reserved CPE may be made when an FDM is performed with a reservation. A priority CPE may not be used when a selection is made with at least a partial overlap because using the priority CPE may indicate that one reservation takes priority as compared to another reservation. Instead, collision may be accepted, and the reserved CPE may be used.

A reserved CPE may be associated with a partial resource block set allocation. For example, the reserved CPE may be open only to, but not necessarily used by, the partial resource block set allocation. For a full resource block set, a reserved CPE may be used (e.g., only priority CPE). Candidate resources from a PHY layer may be marked as a candidate slot not overlapped with reservations, a candidate slot overlapped with reservations (but no overlap of subchannels), or a candidate slot overlapped with reservations (and overlap of subchannels). When a MAC layer selects the candidate slot not overlapped with reservations, and for a partial resource block set, a priority CPE may be used for a first transmission and a reserved CPE may be used for a retransmission. When the MAC layer selects the candidate slot not overlapped with reservations, and for a partial resource block set, a reserved CPE may be used. When a MAC layer selects the candidate slot overlapped with reservations (and overlap of subchannels), and for a partial resource block set, a priority CPE may be used.

Multiple CPE starting positions may not be desirable for SL-U. A single CPE starting position may be preferred for an FDM of UEs, as opposed to multiple CPE starting positions, which may not enable the FDM of UEs. Without multiple CPE starting positions, collisions between different UEs may be more likely, thereby degrading UE performance.

In various aspects of techniques and apparatuses described herein, a UE may receive, from a network node, a configuration that indicates one or more CPE starting positions. The one or more CPE starting positions may refer to a single CPE starting position or may refer to multiple CPE starting positions. The configuration may be on a per-resource-pool basis. The configuration may be associated with a mode 2 resource allocation. The UE may transmit a sidelink transmission using a selected CPE starting position, of the one or more CPE starting positions, based at least in part on the configuration received from the network node. In some aspects, in SL-U, both the single CPE starting position and the multiple CPE starting positions may be supported for collision resolution, while still preserving an FDM capability.

FIG. 9 is a diagram illustrating an example 900 associated with a configuration of CPE starting positions, in accordance with the present disclosure. As shown in FIG. 9, example 900 includes communication between a UE (e.g., UE 120) and a network node (e.g., network node 110). In some aspects, the UE and the network node may be included in a wireless network, such as wireless network 100.

As shown by reference number 902, the UE may receive, from the network node, a configuration that indicates one or more CPE starting positions. The one or more CPE starting positions may refer to a single CPE starting position or may refer to multiple CPE starting positions. The configuration may be on a per-resource-pool basis. The configuration may be associated with a mode 2 resource allocation. In some aspects, the single CPE starting position may be configured, and a location of the single CPE starting position may be pre-configured or indicated in sidelink control information (SCI). In some aspects, the multiple CPE starting positions may be configured, and respective locations of the multiple CPE starting positions may be pre-configured or indicated dynamically via SCI. In some aspects, the configuration may indicate a location associated with the single CPE starting position or respective locations associated with the multiple CPE starting positions. The configuration may indicate respective priorities associated with the multiple CPE starting positions.

In some aspects, the configuration may be per-resource-pool to determine whether only the single CPE starting position or the multiple CPE starting positions are permitted in a particular resource pool. In a resource pool with the single CPE starting position, a CPE may be preconfigured or indicated in SCI (e.g., in COT sharing information). In a resource pool that permits the multiple CPE starting positions, multiple configurations of CPE starting positions may be pre-configured, or indicated dynamically (e.g., via SCI). Each configuration may indicate respective locations of CPEs, an association with priorities for multiple CPEs, and/or a reserved CPE and a corresponding location.

In some aspects, a quantity of configured CPE starting positions may be based at least in part on a specific channel or signal associated with a sidelink. For example, the single CPE starting position may be configured for a PSFCH, and the multiple CPE starting positions may be configured for a PSCCH and/or a PSSCH.

In some aspects, the multiple CPE starting positions may be configured. The multiple CPE starting positions may include a set of priority CPE starting positions and/or a reserved CPE starting position. The set of priority CPE starting positions may be used based at least in part on a pre-configuration for specific channels or signals associated with a sidelink. The reserved CPE starting position may be used based at least in part on a pre-configuration for specific channels or signals associated with a sidelink.

In some aspects, a use of the reserved CPE starting position may be associated at least in part with a resource allocation on a subset of available subchannels in a resource block set, or in a set of resource block sets based at least in part on the resource allocation spanning more than one resource block set. In some aspects, a use of the reserved CPE starting position may be associated at least in part with a sidelink transmission being performed using reserved resources. In some aspects, a use of the reserved CPE starting position may be associated at least in part with a detection of a reservation for a different transmission in a same slot from another UE. A resource may be allocated to FDM with the different transmission. In some aspects, the set of priority CPE starting positions may be located prior to the reserved CPE starting position. In some aspects, the set of priority CPE starting positions may be located after the reserved CPE starting position.

In some aspects, a scheme for selecting a CPE for starting a transmission based at least in part on a configuration of available CPE starting positions and criteria for selecting the CPE may be defined. A set of CPE starting positions associated with a priority may be used. The set of CPE starting positions may be used based at least in part on the pre-configuration for specific channels or signals, such as a PSCCH and/or a PSSCH. The reserved CPE starting position may be used based at least in part on the pre-configuration for specific channels or signals, such as a PSFCH, a PSCCH, and/or a PSSCH. The reserved CPE starting position may be used for a PSCCH and/or a PSSCH associated with the resource allocation on the subset of subchannels available in the resource block set (or in the set of resource block sets, in case the resource allocation spans more than one resource block set). The reserved CPE starting position may be used for the PSCCH and/or the PSSCH associated with performing the sidelink transmission for which resources were reserved (e.g., no first transmission). The reserved CPE starting position may be used for the PSCCH and/or the PSSCH associated with detecting a reservation for a transmission from another UE (e.g., the transmission may be started in the same slot) with no resource collision (e.g., resource to FDM may be allocated with that transmission). In some aspects, when both the set of CPE starting positions and the reserved CPE starting position are used, the set of CPE starting positions may occur first and the reserved CPE starting position may occur second, or alternatively, the reserved CPE starting position may occur first and the set of CPE starting positions may occur second.

In some aspects, a report may be triggered to identify a candidate resource, among a plurality of candidate resources, for selection based at least in part on multiple configured CPE starting positions. The report may indicate a first value. The first value may indicate that, in a first slot of the candidate resource, no reservations from other UEs have been detected. In other words, related to the first slot of the candidate resource, no reservations were detected that reserve a transmission starting in the same first slot. The report may indicate a second value.

The second value may indicate that, in the first slot of the candidate resource, reservations from other UEs have been detected and no overlapping subchannels associated with the candidate resource. In other words, related to the first slot of the candidate resource, no reservations were detected that reserve a transmission starting in the same first slot and with overlapped subchannels. The report may indicate a third value. The third value may indicate that, in the first slot of the candidate resource, reservations from other UEs have been detected and a presence of overlap in terms of subchannels associated with the candidate resource.

In some aspects, an additional report may be transmitted from a PHY layer to a MAC layer when a resource exclusion is triggered to identify the candidate resource for selection, which may be to support the scheme for selecting the CPE for starting the transmission based at least in part on the configuration of available CPE starting positions and criteria for selecting the CPE. The PHY layer may mark each candidate resource reported to the MAC layer for selection with the first value, the second value, or the third value. The PHY layer may mark a candidate resource with the first value when, in a first slot of the candidate resource, no reservations from other UEs were detected (e.g., no RSRP exclusion tests were performed). The PHY layer may mark a candidate resource with the second value when, in the first slot of the candidate resource, reservations from other UEs were detected, but no overlapping subchannels exists with the candidate resource under analysis (e.g., the candidate resource was not subject to RSRP exclusion test). The PHY layer may mark a candidate resource with the third value when, in the first slot of the candidate resource, reservations from other UEs were detected, and there was overlap in terms of subchannels with the candidate resource under analysis (e.g., the candidate resource was tested for RSRP exclusion test and the candidate resource was not excluded).

As shown by reference number 904, the UE may transmit a sidelink transmission using a selected CPE starting position, of the one or more CPE starting positions, based at least in part on the configuration received from the network node. The UE may transmit the sidelink transmission to another UE. The UE may transmit the sidelink transmission using the single CPE starting position. Alternatively, the UE may transmit the sidelink transmission using the selected CPE starting position, which may be selected from the multiple CPE starting position.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with a configuration of CPE starting positions.

As shown in FIG. 10, in some aspects, process 1000 may include receiving, from a network node, a configuration that indicates one or more CPE starting positions (block 1010).

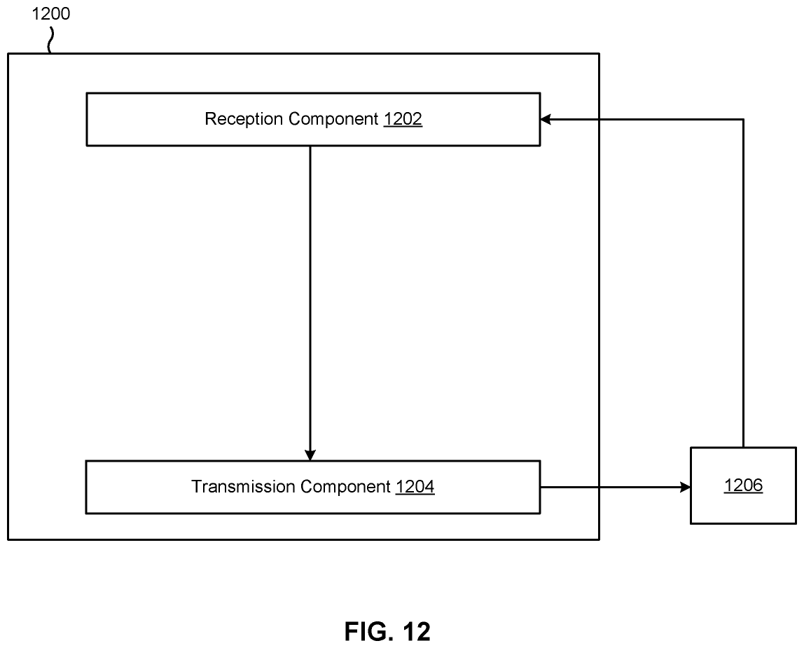

For example, the UE (e.g., using reception component 1202, depicted in FIG. 12) may receive, from a network node, a configuration that indicates one or more CPE starting positions, as described above.

As further shown in FIG. 10, in some aspects, process 1000 may include transmitting a sidelink transmission using a selected CPE starting position, of the one or more CPE starting positions, based at least in part on the configuration received from the network node (block 1020). For example, the UE (e.g., using transmission component 1204, depicted in FIG. 12) may transmit a sidelink transmission using a selected CPE starting position, of the one or more CPE starting positions, based at least in part on the configuration received from the network node, as described above.

Process 1000 may include additional aspects, such as any single aspect or any combination of aspects described below and/or in connection with one or more other processes described elsewhere herein.

In a first aspect, the configuration is on a per-resource-pool basis.

In a second aspect, alone or in combination with the first aspect, the configuration is associated with a mode 2 resource allocation.

In a third aspect, alone or in combination with one or more of the first and second aspects, a single CPE starting position is configured, and a location of the single CPE starting position is pre-configured or indicated in SCI.

In a fourth aspect, alone or in combination with one or more of the first through third aspects, multiple CPE starting positions are configured, and respective locations of the multiple CPE starting positions are pre-configured or indicated dynamically via SCI.

In a fifth aspect, alone or in combination with one or more of the first through fourth aspects, the configuration indicates a location associated with a single CPE starting position or respective locations associated with multiple CPE starting positions, or the configuration indicates respective priorities associated with the multiple CPE starting positions.

In a sixth aspect, alone or in combination with one or more of the first through fifth aspects, a quantity of configured CPE starting positions is based at least in part on a specific channel or signal associated with a sidelink.

In a seventh aspect, alone or in combination with one or more of the first through sixth aspects, multiple CPE starting positions are configured, and the multiple CPE starting positions includes one or more of a set of priority CPE starting positions or a reserved CPE starting position.

In an eighth aspect, alone or in combination with one or more of the first through seventh aspects, one of the set of priority CPE starting positions or the reserved CPE starting position is used based at least in part on a pre-configuration for specific channels or signals associated with a sidelink.

In a ninth aspect, alone or in combination with one or more of the first through eighth aspects, a use of the reserved CPE starting position is associated at least in part with a resource allocation on a subset of available subchannels in a resource block set, or in a set of resource block sets based at least in part on the resource allocation spanning more than one resource block set.

In a tenth aspect, alone or in combination with one or more of the first through ninth aspects, a use of the reserved CPE starting position is associated at least in part with the sidelink transmission being performed using reserved resources.

In an eleventh aspect, alone or in combination with one or more of the first through tenth aspects, a use of the reserved CPE starting position is associated at least in part with a detection of a reservation for a different transmission in a same slot from another UE, and a resource is allocated to FDM with the different transmission.

In a twelfth aspect, alone or in combination with one or more of the first through eleventh aspects, the set of priority CPE starting positions is located prior to the reserved CPE starting position, or the set of priority CPE starting positions is located after the reserved CPE starting position.

In a thirteenth aspect, alone or in combination with one or more of the first through twelfth aspects, a report is triggered to identify a candidate resource, among a plurality of candidate resources, for selection based at least in part on multiple configured CPE starting positions, and the report indicates a first value indicating that, in a first slot of the candidate resource, no reservations from other UEs have been detected, a second value indicating that, in the first slot of the candidate resource, reservations from other UEs have been detected and no overlapping subchannels associated with the candidate resource, or a third value indicating that, in the first slot of the candidate resource, reservations from other UEs have been detected and a presence of overlap in terms of subchannels associated with the candidate resource.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with a configuration of CPE starting positions.

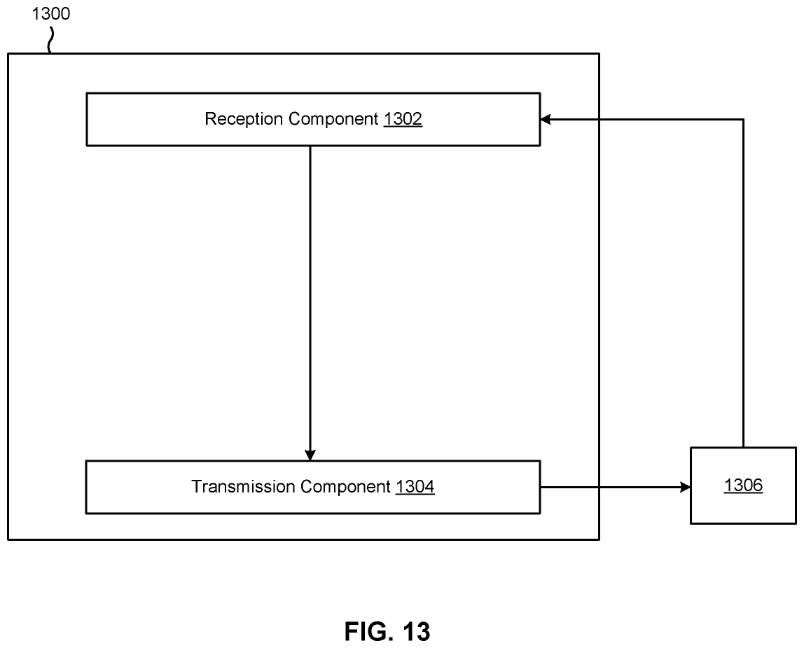

As shown in FIG. 11, in some aspects, process 1100 may include transmitting, to a UE, a configuration that indicates one or more CPE starting positions, wherein a sidelink transmission using a selected CPE starting position, of the one or more CPE starting positions is based at least in part on the configuration (block 1110). For example, the network node (e.g., using transmission component 1304, depicted in FIG. 13) may transmit, to a UE, a configuration that indicates one or more CPE starting positions, wherein a sidelink transmission using a selected CPE starting position, of the one or more CPE starting positions is based at least in part on the configuration, as described above.

Process 1100 may include additional aspects, such as any single aspect or any combination of aspects described below and/or in connection with one or more other processes described elsewhere herein.

In a first aspect, the configuration is on a per-resource-pool basis.

In a second aspect, alone or in combination with the first aspect, the configuration is associated with a mode 2 resource allocation.

In a third aspect, alone or in combination with one or more of the first and second aspects, a single CPE starting position is configured, and a location of the single CPE starting position is pre-configured or indicated in SCI.

In a fourth aspect, alone or in combination with one or more of the first through third aspects, multiple CPE starting positions are configured, and respective locations of the multiple CPE starting positions are pre-configured or indicated dynamically via SCI.

In a fifth aspect, alone or in combination with one or more of the first through fourth aspects, the configuration indicates a location associated with a single CPE starting position or respective locations associated with multiple CPE starting positions, or the configuration indicates respective priorities associated with the multiple CPE starting positions.

In a sixth aspect, alone or in combination with one or more of the first through fifth aspects, a quantity of configured CPE starting positions is based at least in part on a specific channel or signal associated with a sidelink.

In a seventh aspect, alone or in combination with one or more of the first through sixth aspects, multiple CPE starting positions are configured, and the multiple CPE starting positions includes one or more of a set of priority CPE starting positions or a reserved CPE starting position.

In an eighth aspect, alone or in combination with one or more of the first through seventh aspects, one of the set of priority CPE starting positions or the reserved CPE starting position is used based at least in part on a pre-configuration for specific channels or signals associated with a sidelink.

In a ninth aspect, alone or in combination with one or more of the first through eighth aspects, a use of the reserved CPE starting position is associated at least in part with a resource allocation on a subset of available subchannels in a resource block set, or in a set of resource block sets based at least in part on the resource allocation spanning more than one resource block set.

In a tenth aspect, alone or in combination with one or more of the first through ninth aspects, a use of the reserved CPE starting position is associated at least in part with the sidelink transmission being performed using reserved resources.

In an eleventh aspect, alone or in combination with one or more of the first through tenth aspects, a use of the reserved CPE starting position is associated at least in part with a detection of a reservation for a different transmission in a same slot from another UE, and a resource is allocated to FDM with the different transmission.

In a twelfth aspect, alone or in combination with one or more of the first through eleventh aspects, the set of priority CPE starting positions is located prior to the reserved CPE starting position, or the set of priority CPE starting positions is located after the reserved CPE starting position.

In a thirteenth aspect, alone or in combination with one or more of the first through twelfth aspects, a report is triggered to identify a candidate resource, among a plurality of candidate resources, for selection based at least in part on multiple configured CPE starting positions, and the report indicates a first value indicating that, in a first slot of the candidate resource, no reservations from other UEs have been detected, a second value indicating that, in the first slot of the candidate resource, reservations from other UEs have been detected and no overlapping subchannels associated with the candidate resource, or a third value indicating that, in the first slot of the candidate resource, reservations from other UEs have been detected and a presence of overlap in terms of subchannels associated with the candidate resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a network node, a configuration that indicates one or more CPE starting positions. The transmission component 1204 may transmit a sidelink transmission using a selected CPE starting position, of the one or more CPE starting positions, based at least in part on the configuration received from the network node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, a configuration that indicates one or more CPE starting positions, wherein a sidelink transmission using a selected CPE starting position, of the one or more CPE starting positions is based at least in part on the configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, a configuration that indicates one or more cyclic prefix extension (CPE) starting positions; and transmitting a sidelink transmission using a selected CPE starting position, of the one or more CPE starting positions, based at least in part on the configuration received from the network node.

Aspect 2: The method of Aspect 1, wherein the configuration is on a per-resource-pool basis.

Aspect 3: The method of any of Aspects 1-2, wherein the configuration is associated with a mode 2 resource allocation.

Aspect 4: The method of any of Aspects 1-3, wherein a single CPE starting position is configured, and wherein a location of the single CPE starting position is pre-configured or indicated in sidelink control information.

Aspect 5: The method of any of Aspects 1-4, wherein multiple CPE starting positions are configured, and wherein respective locations of the multiple CPE starting positions are pre-configured or indicated dynamically via sidelink control information.

Aspect 6: The method of any of Aspects 1-5, wherein the configuration indicates a location associated with a single CPE starting position or respective locations associated with multiple CPE starting positions, or wherein the configuration indicates respective priorities associated with the multiple CPE starting positions.

Aspect 7: The method of any of Aspects 1-6, wherein a quantity of configured CPE starting positions is based at least in part on a specific channel or signal associated with a sidelink.

Aspect 8: The method of any of Aspects 1-7, wherein multiple CPE starting positions are configured, and wherein the multiple CPE starting positions includes one or more of a set of priority CPE starting positions or a reserved CPE starting position.

Aspect 9: The method of Aspect 8, wherein one of the set of priority CPE starting positions or the reserved CPE starting position is used based at least in part on a pre-configuration for specific channels or signals associated with a sidelink.

Aspect 10: The method of Aspect 8, wherein a use of the reserved CPE starting position is associated at least in part with a resource allocation on a subset of available subchannels in a resource block set, or in a set of resource block sets based at least in part on the resource allocation spanning more than one resource block set.

Aspect 11: The method of Aspect 8, wherein a use of the reserved CPE starting position is associated at least in part with the sidelink transmission being performed using reserved resources.

Aspect 12: The method of Aspect 8, wherein a use of the reserved CPE starting position is associated at least in part with a detection of a reservation for a different transmission in a same slot from another UE, and wherein a resource is allocated to frequency division multiplex with the different transmission.

Aspect 13: The method of Aspect 8, wherein the set of priority CPE starting positions is located prior to the reserved CPE starting position, or wherein the set of priority CPE starting positions is located after the reserved CPE starting position.

Aspect 14: The method of Aspect 8, wherein a report is triggered to identify a candidate resource, among a plurality of candidate resources, for selection based at least in part on multiple configured CPE starting positions, and wherein the report indicates: a first value indicating that, in a first slot of the candidate resource, no reservations from other UEs have been detected; a second value indicating that, in the first slot of the candidate resource, reservations from other UEs have been detected and no overlapping subchannels associated with the candidate resource; or a third value indicating that, in the first slot of the candidate resource, reservations from other UEs have been detected and a presence of overlap in terms of subchannels associated with the candidate resource.

Aspect 15: A method of wireless communication performed by a network node, comprising: transmitting, to a user equipment (UE), a configuration that indicates one or more cyclic prefix extension (CPE) starting positions, wherein a sidelink transmission using a selected CPE starting position, of the one or more CPE starting positions is based at least in part on the configuration.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a network node, a configuration that indicates one or more cyclic prefix extension (CPE) starting positions; and
transmit a sidelink transmission using a selected CPE starting position, of the one or more CPE starting positions, based at least in part on the configuration received from the network node.

2. The apparatus of claim 1, wherein the configuration is on a per-resource-pool basis, or associated with a mode 2 resource allocation.

3. (canceled)

4. The apparatus of claim 1, wherein a single CPE starting position is configured, and wherein a location of the single CPE starting position is pre-configured or indicated in sidelink control information.

5. The apparatus of claim 1, wherein multiple CPE starting positions are configured, and wherein respective locations of the multiple CPE starting positions are pre-configured or indicated dynamically via sidelink control information.

6. The apparatus of claim 1, wherein the configuration indicates a location associated with a single CPE starting position or respective locations associated with multiple CPE starting positions, or wherein the configuration indicates respective priorities associated with the multiple CPE starting positions.

7. The apparatus of claim 1, wherein a quantity of configured CPE starting positions is based at least in part on a specific channel or signal associated with a sidelink.

8. The apparatus of claim 1, wherein multiple CPE starting positions are configured, and wherein the multiple CPE starting positions includes one or more of a set of priority CPE starting positions or a reserved CPE starting position.

9. The apparatus of claim 8, wherein one of the set of priority CPE starting positions or the reserved CPE starting position is used based at least in part on a pre-configuration for specific channels or signals associated with a sidelink.

10. The apparatus of claim 8, wherein a use of the reserved CPE starting position is associated at least in part with a resource allocation on a subset of available subchannels in a resource block set, or in a set of resource block sets based at least in part on the resource allocation spanning more than one resource block set.

11. The apparatus of claim 8, wherein a use of the reserved CPE starting position is associated at least in part with the sidelink transmission being performed using reserved resources.

12. The apparatus of claim 8, wherein a use of the reserved CPE starting position is associated at least in part with a detection of a reservation for a different transmission in a same slot from another UE, and wherein a resource is allocated to frequency division multiplex with the different transmission.

13. The apparatus of claim 8, wherein the set of priority CPE starting positions is located prior to the reserved CPE starting position, or wherein the set of priority CPE starting positions is located after the reserved CPE starting position.

14. (canceled)

15. An apparatus for wireless communication at a network node, comprising:
a memory; and
one or more processors, coupled to the memory, configured to:
transmit, to a user equipment (UE), a configuration that indicates one or more cyclic prefix extension (CPE) starting positions, wherein a sidelink transmission using a selected CPE starting position, of the one or more CPE starting positions is based at least in part on the configuration.

16. A method of wireless communication performed by a user equipment (UE), comprising:
receiving, from a network node, a configuration that indicates one or more cyclic prefix extension (CPE) starting positions; and
transmitting a sidelink transmission using a selected CPE starting position, of the one or more CPE starting positions, based at least in part on the configuration received from the network node.

17. The method of claim 16, wherein the configuration is on a per-resource-pool basis, or associated with a mode 2 resource allocation.

18. (canceled)

19. The method of claim 16, wherein a single CPE starting position is configured, and wherein a location of the single CPE starting position is pre-configured or indicated in sidelink control information.

20. The method of claim 16, wherein multiple CPE starting positions are configured, and wherein respective locations of the multiple CPE starting positions are pre-configured or indicated dynamically via sidelink control information.

21. The method of claim 16, wherein the configuration indicates a location associated with a single CPE starting position or respective locations associated with multiple CPE starting positions, or wherein the configuration indicates respective priorities associated with the multiple CPE starting positions.

22. The method of claim 16, wherein a quantity of configured CPE starting positions is based at least in part on a specific channel or signal associated with a sidelink.

23. The method of claim 16, wherein multiple CPE starting positions are configured, and wherein the multiple CPE starting positions includes one or more of a set of priority CPE starting positions or a reserved CPE starting position.

24. (canceled)

25. (canceled)

26. (canceled)

27. (canceled)

28. (canceled)

29. (canceled)

30. (canceled)
